(19) United States
(12) Patent Application Publication
(10) Pub. No.: US 2011/0039686 A1
(43) Pub. Date: Feb. 17, 2011

(54) Fast regeneration of sulfur deactivated Ni-based hot biomass syngas cleaning catalysts

(75) Inventors: Liyu Li, Richland, WA (US); Christopher J. Howard, Richland, WA (US); David L. King, Richland, WA (US); Mark A. Gerber, Richland, WA (US); Robert A. Dagle, Richland, WA (US); Don J. Stevens, Kennewick, WA (US)

Correspondence Address: BATTELLE MEMORIAL INSTITUTE;ATTN: IP SERVICES, K1-53, P. O. BOX 999, RICHLAND, WA, 99352, US

(73) Assignee: BATTELLE MEMORIAL INSTITUTE, Richland, WA (US)

(21) Appl. No.: 12/856,239

(22) Filed: Aug. 13, 2010

Related U.S. Application Data
(60) Provisional application No. 61/233,902, filed on Aug. 14, 2009.

(51) Int. Cl. B01J 38/12

(52) U.S. Cl. 502/38

(57) ABSTRACT

A new regeneration method has been developed which can effectively and efficiently remove sulfur from Ni-based steam reforming catalysts. In its simplest form the present invention comprises the steps of oxidizing a catalyst with a dilute O₂ stream; decomposing the nickel sulfate under inert gas stream and removing sub-surface sulfur under steam reforming conditions. In some embodiments these steps can all be accomplished and the regenerated catalyst be reintroduced to a steam reforming operation in a matter of eight hours or less.

### CLAIM TO PRIORITY

This application claims priority from a provisional patent application no 61/233,902 filed Aug. 14, 2009 the contents of which are hereby incorporated by reference in their entirety.

### STATEMENT AS TO RIGHTS TO INVENTIONS MADE UNDER FEDERALLY-SPONSORED RESEARCH AND DEVELOPMENT

This invention was made with Government support under Contract DE-AC0576RLO1830 awarded by the U.S. Department of Energy. The Government has certain rights in the invention.

### BACKGROUND OF THE INVENTION

Nickel based catalysts have enjoyed a long-successful practice in hydrogen production from steam-reforming of hydrocarbons and methane. Nickel-based catalysts have also been widely tested for decomposing tar and reforming excess methane in hot biomass syngas cleanup processes. However, the sulfur in tar greatly decreases the reforming performance of Ni catalyst due to the strong chemisorption of sulfur on Ni surface. Unlike other sulfur species in syngas (such as H₂S and COS), the sulfur in tar can not be readily removed by the conventional hot syngas desulfurization process using ZnO-based absorbents. As a result, periodic regeneration of Ni-reforming catalyst is required.

Since the Ni surface chemisorption of sulfur is reversible, the sulfur-deactivated Ni catalysts can be regenerated in a reducing environment at high temperature. The major disadvantage of this regeneration process is its slow sulfur removal rate, which is exponential with time. This process also requires a large volume of sulfur-free reducing gas. In industrial hydrogen production practice, under desulfurization unit upset conditions, sulfur-poisoned steam reforming catalysts are regenerated by sequential treatments of steam, steam-air mixture, and steaming-hydrogen mixture (H₂O to H₂ molar ratio of 100).

Steaming treatment removes some sulfur in the form of SO₂ and H₂5 and oxidizes Ni via the following reactions

Ni—S+H₂O=NiO+H₂S (1)

H₂S +2H₂O=SO₂+3H₂ (2)

Ni+H₂O=NiO+H₂ (3)

Carbon formation is nearly always observed on sulfur-poisoned Ni catalysts. The introduction of small amount of air with steam can completely remove aged carbon deposits as CO₂:

2Ni—C+3O₂=2NiO+2CO₂ (4)

Some NiSO₄ always forms during steam and steam/air treatments, which requires further treatment with steam/hydrogen mixture at molar ratio of H₂O/H₂ about 100. Under this condition, NiSO₄ decomposes to NiO and sulfur is removed as H₂S:

NiSO₄+4H₂=NiO+H₂S+3H₂O (5)

After sulfur removal, the catalysts are further reduced in H₂ and then put back to steam reforming reaction condition. Normally this process can effectively remove the sulfur absorbed on the surface of Ni catalysts, and can restore their reforming performance. One disadvantage with using this regeneration process for periodic regeneration of tar cracking Ni-based catalysts is that it is a time-consuming process, which can easily take up to two to three days. The present invention is a new regeneration process, which can effectively and efficiently remove sulfur from the Ni-based reforming catalyst and restore its catalytic activity.

What is needed therefore is a method for regenerating catalysts that effectively removes sulfur contamination from Ni-based steam reforming catalysts. The present invention meets this need.

Additional advantages and novel features of the present invention will be set forth as follows and will be readily apparent from the descriptions and demonstrations set forth herein. Accordingly, the following descriptions of the present invention should be seen as illustrative of the invention and not as limiting in any way.

### SUMMARY OF THE INVENTION

A new regeneration method has been developed which can effectively and efficiently remove sulfur from Ni-based steam reforming catalysts. In its simplest form the present invention comprises the steps of oxidizing a catalyst with a dilute O₂ stream; decomposing the nickel sulfate under inert gas stream and removing sub-surface sulfur under steam reforming conditions. In some embodiments these steps can all be accomplished and the regenerated catalyst be reintroduced to a steam reforming operation in a matter of eight hours or less.

Compared to the previously reported high temperature reduction process and the steam oxidation process, this new oxidation-decomposition-reduction method can effectively and efficiently remove both the surface sulfur and the sub-surface sulfur and, thus, completely regenerate the sulfur-poisoned Ni catalysts. This invention includes a catalyst regeneration process for Ni based catalysts said process comprising the steps of: oxidizing a catalyst with a dilute 02 stream; decomposing nickel sulfate under inert gas stream and removing sub-surface sulfur under steam reforming conditions. This method can be performed in a variety of ways. Various examples of which are provided in the detailed description of the invention provided here after. While these various descriptions are provided it is to be distinctly understood that the invention is not limited thereto

In one application of the present invention a regeneration method was performed including four steps:

(1) oxidation at 750° C. in 1% O₂ at 12,000 hr⁻¹ GHSV for 3 hours;

(2) decomposition at 900° C. in Ar at 12,000 hr⁻¹ GHSV for 1 hour;

(3) reduction at 900° C. in 2% H₂ at 24,000 hr⁻¹ GHSV for 1 hour;

(4) reaction at 900° C. under biomass syngas reforming condition for 2 hours.

This novel regeneration only needs about 8 hours, which is much faster than the conventional regeneration process. After regeneration, the reforming performance of the deactivated reforming catalyst was recovered.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions I have shown and described only the preferred embodiment of the invention, by way of illustration of the best mode contemplated for carrying out the invention. As will be realized, the invention is capable of modification in various respects without departing from the invention. Accordingly, the drawings and description of the preferred embodiment set forth hereafter are to be regarded as illustrative in nature, and not as restrictive.

### BRIEF DESCRIPTION OF THE DRAWINGS

FIG. 1 shows sulfur effect on CH₄ steam reforming activity of a commercial 20 wt % Ni—Al₂O₃ catalyst (G90-B from United Catalyst). Test conditions: T=750° C., sulfur-free syngas: H₂ 18.8%, H₂O 50.0%, CO₂ 11.8%, CO 13.1%, CH₄ 6.3%. flow rate: 36,000 hr⁻¹ GHSV.

FIGS. 2a-2e show catalyst steam reforming performance after sulfur exposure and regeneration under different conditions. Sulfur exposure condition: 750° C., 300 sccm 50 ppm H₂S, 17.9% H₂, 47.5% H₂O, 12.4% CO, 11.2% CO₂, 6.0% CH₄ and 5.0% He for 4 hours. Reaction condition: 750° C., 18.8% H₂, 50.0% H₂O, 13.1% CO, 11.8% CO₂, 6.3% CH₄. 36,000 hr⁻¹ GHSV. Regeneration conditions:

FIG. 2 (a) shows Conventional sequential steam, steam/air, and steam/hydrogen treatment. T=650° C., 3.7 sccm air and 150 sccm H₂O for 2 hours; 1.5 sccm H₂, 35.8 sccm N₂, and 150 sccm H₂O for 18 hours; 20 sccm H₂ and 180 sccm Ar for 2 hours.

FIG. 2(b) shows High temperature reaction treatment. T=900° C., 300 sccm of sulfur-free syngas (H₂ 18.8%, H₂O 50.0%, CO₂ 11.8%, CO 13.1%, CH₄ 6.3%) for 8 hours.

FIG. 2(c) shows High temperature steaming. T=900° C., 120 sccm H₂O and 30 sccm N₂ for 8 hours.

FIG. 2(d) Controlled oxidation. T=750° C., 100 sccm N₂ and 5 sccm air for 4 hours.

FIG. 2(e) Oxidation-decomposition-reduction treatment. T=750° C., 200 sccm Ar and 10 sccm air for 30 minutes; ramping to 850° C. in 200 sccm Ar at 5° C./min and holding in Ar for 1.5 hour; at 850° C. in 300 sccm Ar and 6 sccm H₂ for 30 minutes; in 200 sccm Ar to 750° C.

FIGS. 3a-3c show sulfur removal profile during regeneration treatment. Regeneration conditions: (a) Controlled oxidation treatment. T=750° C., 100 sccm N₂ and 5 sccm air. (b) Oxidation-decomposition-reduction treatment. T=750° C., 200 sccm Ar and 10 sccm air for 30 minutes; ramping to 850° C. in 200 sccm Ar at 5° C./min and holding in Ar for 1.5 hour; at 850° C. in 300 sccm Ar and 6 sccm H₂ for 30 minutes; in 200 sccm Ar to 750° C. (c) High temperature reaction treatment. T=900° C., 300 sccm of sulfur-free syngas (H₂ 18.8%, H₂O 50.0%, CO₂ 11.8%, CO 13.1%, CH₄ 6.3%).

FIG. 3a gives the sulfur removal profile during controlled oxidation in 1% O₂ at 750° C.

FIG. 3b gives the sulfur removal profile during an “oxidation-decomposition” regeneration process.

FIG. 4a gives the CH₄ reforming performance of G90-B catalyst at 750° C. before and after this regeneration, indicating that the catalyst's activity was recovered by this new process.

FIG. 4b gives the sulfur removal profile during regeneration. Total sulfur measured by the GC-SCD system downstream of the water condenser and the 50-tube Nafion membrane dryer during regeneration was more than 80% of that absorbed on the catalyst during sulfur exposure treatment.

FIG. 5. Performance of sulfur-poisoned Ni-based steam reforming catalyst at 750° C. regenerated as: (1) oxidation at 750° C. in 1% O₂ at 12,000 hr⁻¹ GHSV

for 3 hours; (2) decomposition in Ar at 12,000 hr⁻¹ GHSV as temperature ramping up from 750° C. to 900° C. at 5° C./min heating rate and holding at 900° C. for 1 hour; (3) reaction at 900° C. in biomass syngas at 36,000 hr⁻¹ GHSV for 2 hours. Without the 2% H₂ treatment step, the long-term performance of the regenerated catalyst was not stable.

### DETAILED DESCRIPTION OF THE INVENTION

The following description includes a preferred best mode of one embodiment of the present invention. It will be clear from this description of the invention that the invention is not limited to these illustrated embodiments but that the invention also includes a variety of modifications and embodiments thereto. Therefore the present description should be seen as illustrative and not limiting. While the invention is susceptible of various modifications and alternative constructions, It should be understood, that there is no intention to limit the invention to the specific form disclosed, but, on the contrary, the invention is to cover all modifications, alternative constructions, and equivalents falling within the spirit and scope of the invention as defined in the claims.

In one preferred embodiment of the invention steam reforming of CH₄ in biomass syngas (18.4% H₂, 11.4% CO₂, 12.7% CO, 6.2% CH₄, 2.9% N₂ and 48.4% H₂O) at 750° C. was used as a model reaction. A commercial Ca-promoted 20 wt % Ni on Al₂O₃ reforming catalyst (G90-B from United Catalyst) was used throughout this work. About 0.5 gram of 60-100 mesh catalyst particles was loaded into a ¼ stainless steel fixed bed reactor, which was heated in a clam-shell furnace. Before the CH₄ reforming test, the catalyst was reduced in 200 sccm (24,000 hr⁻¹ gas hourly space velocity-GHSV) 10% H₂ in Ar at 500° C. for 4 hours. Then the reforming activity of the refresh catalyst was measured in 300 sccm sulfur free syngas at 750° C. for 12 to 16 hours. After that, 50 ppm H₂S was introduced into the biomass syngas to deactivate the Ni catalyst. This sulfur treatment normally lasted four hours. Then the catalyst was regenerated under different conditions. After regeneration, the CH₄ reforming activity was measured again in 300 sccm sulfur-free syngas at 750° C. Flows of biomass syngas, 1000 ppm H₂S in He, and regeneration gases (air, Ar, N₂, H₂) were metered using MKS mass flow controllers. Steam was generated using a small cartridge vaporizer and steam flow was controlled by a HPLC pump. Downstream of the absorption bed, water was removed with a condenser followed by a 50-tube Nafion membrane dryer (Perma Pure LLC, Toms River, N.J., USA). The syngas composition including the sulfur level was monitored continuously during reaction and regeneration using a micro gas chromatography (micro-GC, Agilent 3000A) and a sulfur chemiluminescence detector (SCD) installed on an Agilent 6890 GC. This GC-SCD system has a sulfur detection limit of 10 ppbv. The sulfur-free biomass syngas used in this work contains about 20 ppbv sulfur.

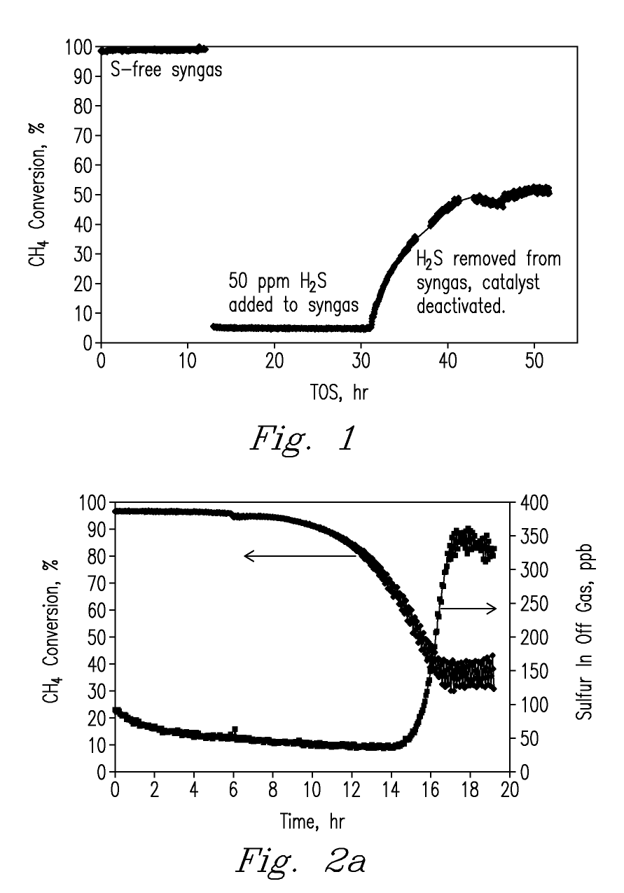

FIG. 1 shows, at 750° C., 50 ppm H₂S in syngas can dramatically decrease the CH₄ steam reforming activity of the Ni catalyst G90-B. When H₂S was removed from the syngas, the catalyst's reforming activity only partially recovered. Only about 0.06 wt % sulfur was absorbed by this catalyst during sulfur exposure.

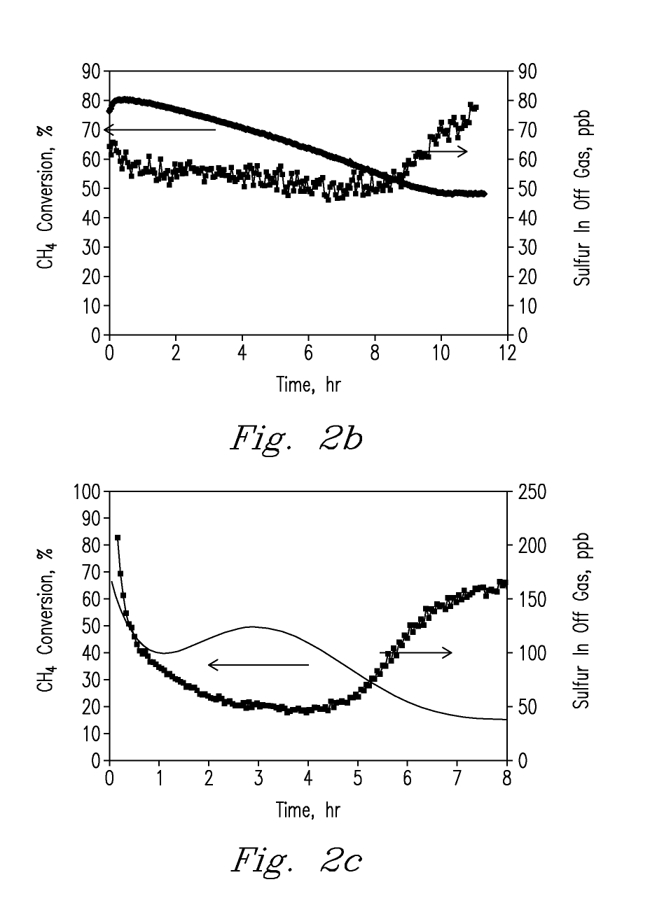

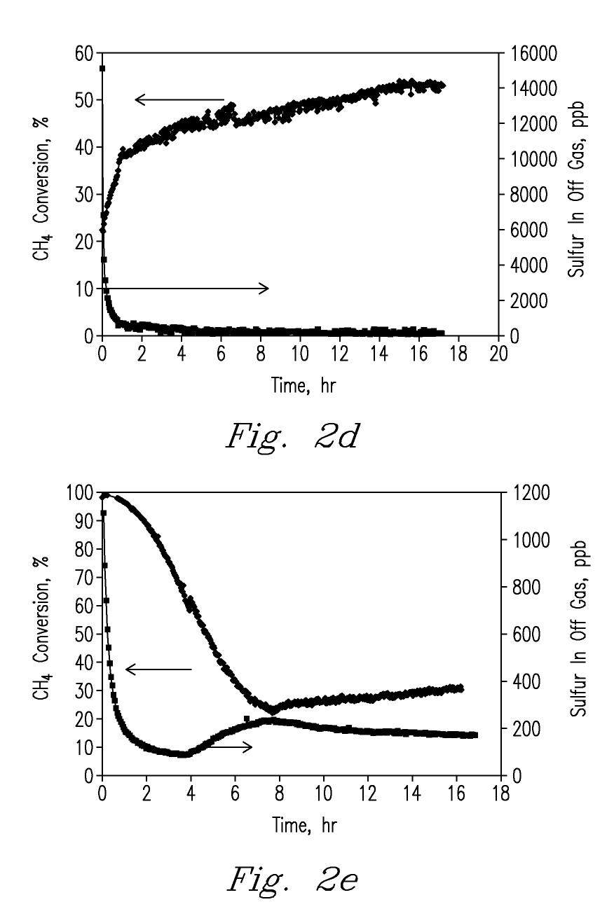

To effectively regenerate the sulfur-poisoned reforming catalyst, several regeneration methods were evaluated, including the conventional sequential steam, steam/air, and steam/hydrogen treatment, high temperature (900° C.) sulfur-free syngas reforming reaction treatment, high temperature (900° C.) steaming, controlled oxidation in 1% O₂ gas at 750° C., and oxidation-decomposition treatment. Detail regeneration conditions and the CH4 reforming performance at 750° C. after regeneration using these methods are given in FIGS. 2a-2e. All these methods were found not effective in removing sulfur from the deactivated catalyst, including the conventional sequential steam, steam/air, and steam/hydrogen treatment. In this work a short treatment duration (<24 hours) was used when carrying out this conventional regeneration process in order to develop a fast regeneration method. Although no sulfur was added to the feed syngas during the reaction after regeneration, a certain amount of sulfur, previously absorbed on the catalyst and not effectively removed by the regeneration treatment, was released into the gas stream during each test. Besides the CH₄ reforming activity, the sulfur concentration in off-gas can also be used to evaluate the effectiveness of each regeneration method.

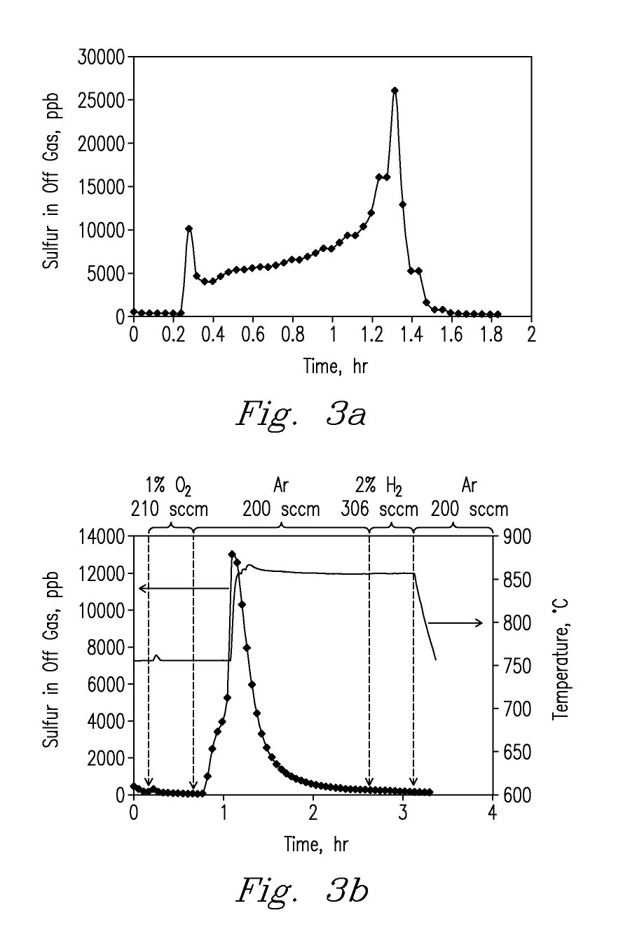

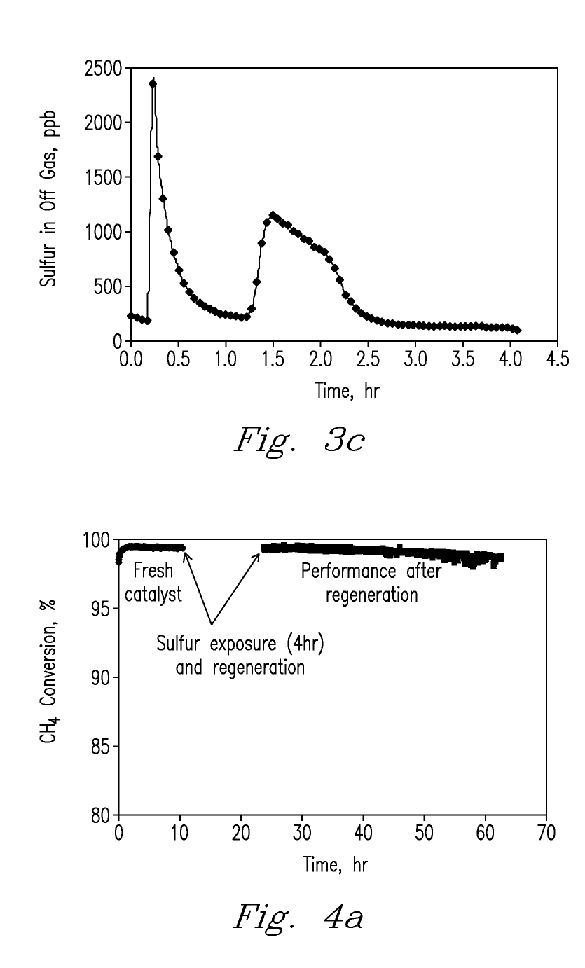

During these screening tests, three promising treatment processes were identified, including controlled oxidation in low flow rate (12,000 hr⁻¹ GHSV) 1% O₂ at 750° C., oxidation followed by decomposition in inert gas at high temperature (>850° C.), and high temperature (900° C.) reforming reaction treatment. Although none of these treatments effectively regenerated the sulfur-poisoned catalyst, significant amount of sulfur was removed during each treatment. FIG. 3 gives the sulfur level during these treatments.

FIG. 3a gives the sulfur removal profile during controlled oxidation in 1% O₂ at 750° C. When limited amount of O₂ (100 ml/min, 12,000 hr⁻¹ GHSV) was introduced, some sulfur absorbed on the Ni catalyst was removed as SO₂ (reaction 6). However, when higher flow rate (200 ml/min, 24,000 hr⁻¹ GHSV) was used, almost no sulfur was removed. It seems with excess O₂ around, all the sulfur was directly oxidized to NiSO₄ (reaction 7).

Ni—S+3/2O₂=NiO+SO₂ (6)

Ni—S+2O₂=NiSO₄ (7)

To regenerate metallic hydrogenation catalysts, prior art descriptions discuss an oxidation process using gas with oxygen concentration of about 1-10 ppm at ˜400° C. Very long treatment time (up to 600 hours) was required to completely regenerate the deactivated metal catalysts since extremely low oxygen partial pressure was used. Regeneration using gas with higher oxygen concentration (>10 ppm) at 400° C. was reported as being not successful. Hughes patented a similar process for sulfur decontamination of conduits and vessels communicating with hydrocarbon conversion catalyst reactors. Gas with oxygen concentration of <0.1% and a temperature of about 450° C. were used to remove the sulfur in order to prevent SO₃ and sulfate formation, which could damage the downstream catalyst. Efficient sulfur removal shown in FIG. 3a using 1% O₂ is quite possibly due to the high treatment temperature (750° C.) used in this work. Please be noticed that after this treatment the catalyst activity was not recovered (FIG. 2d).

FIG. 3b gives the sulfur removal profile during an “oxidation-decomposition” regeneration process. Since NiSO₄ is not stable at high temperatures (850° C.), after oxidized to NiSO₄, sulfur can be removed by thermal decomposition (reaction 8). Although in theory all the sulfur can be removed by this process at 850° C., in practice only a portion of sulfur was removed and this process could not fully regenerate the deactivated Ni catalyst (FIG. 2e). After switching back to sulfur-free syngas at 750° C., high concentration of sulfur was detected in the off gas. After about 4 hours, sub-surface sulfur migrated to the surface and the catalyst was further deactivated.

2NiSO₄=2NiO+2SO₂+O₂ Kp=1.6×10⁻² at 800° C. (8)

FIG. 3c gives the sulfur removal profile during high temperature (900° C.) reforming reaction treatment. It was observed from FIG. 2 that the effectiveness of the regeneration process is strongly dependent on whether or not it can remove the subsurface sulfur from the catalysts. Under regular reforming reaction condition at 750° C., sub-surface sulfur slowly migrated to the surface of catalyst. At high temperature (900° C.), reforming reaction treatment greatly accelerated the migration of sub-surface sulfur to the surface of catalyst, and then removed it off the catalyst surface. As mentioned before, eight hours' treatment in syngas at 900° C. was not able to effectively regenerate the sulfur-poisoned catalyst (FIG. 2b).

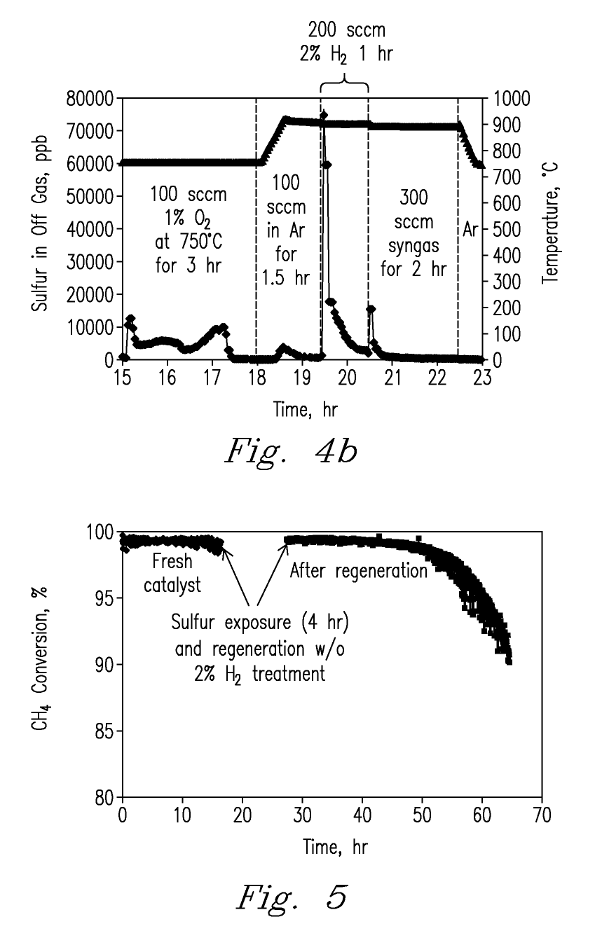

With these understandings, an effective fast regeneration method was developed. This method includes four steps: (1) oxidation at 750° C. in 1% O₂ at 12,000 hr⁻¹ GHSV for 3 hours; (2) decomposition in Ar at 12,000 hr⁻¹ GHSV as temperature ramping up from 750° C. to 900° C. at 5° C./min heating rate and holding at 900° C. for 1 hour; (3) reduction in 2% H₂ at 24,000 hr⁻¹ GHSV for 1 hour; (4) reaction at 900° C. in biomass syngas at 36,000 hr⁻¹ GHSV for 2 hours. This regeneration procedure lasts about 8 hours. FIG. 4a gives the CH₄ reforming performance of G90-B catalyst at 750° C. before and after this regeneration, indicating that the catalyst's activity was recovered by this new process. FIG. 4b gives the sulfur removal profile during regeneration. Total sulfur measured by the GC-SCD system downstream of the water condenser and the 50-tube Nafion membrane dryer during regeneration was more than 80% of that absorbed on the catalyst during sulfur exposure treatment. Considering some sulfur was trapped by the water condensing system and therefore was not detected by the GC-SCD unit, this process has very high sulfur removal efficiency.

The 2% H₂ treatment (step 3) assists to achieve stable long-term performance of the regenerated catalyst. FIG. 5 shows, without step 3, the CH₄ conversion decreased significantly after 25 hours' reaction. This treatment seems provide a relatively “mild” transition for the catalyst from oxidizing condition (step 2, 1% O₂) to reducing condition (step 4, syngas). When 0.5% O₂ was used in step (1), the sulfur-poisoned Ni-catalyst was also successfully regenerated. However, longer regeneration time (>12 hours) was required. Compared to the previously reported high temperature reduction process and the steam oxidation process, this new oxidation-decomposition-reduction method can effectively and efficiently remove bulk sulfide, surface chemisorped sulfur, and the sub-surface sulfur and, thus, completely regenerate the sulfur-poisoned Ni catalysts.

While various preferred embodiments of the invention are shown and described, it is to be distinctly understood that this invention is not limited thereto but may be variously embodied to practice within the scope of the following claims. From the foregoing description, it will be apparent that various changes may be made without departing from the spirit and scope of the invention as defined by the following claims.

What is claimed is:

1) A catalyst regeneration process for Ni based catalysts said process comprising the steps of:
oxidizing said catalyst with a dilute O₂ stream;
decomposing nickel sulfate upon said catalyst under an inert gas stream; and
removing sub-surface sulfur from said catalyst under steam reforming conditions.

2) A method for regenerating Ni-based catalysts comprising the steps of:
oxidizing said catalyst;
decomposing said catalyst;
reducing said catalyst ; and
reacting said catalyst, wherein said oxidizing, decomposing, reducing and reacting steps all take place within less than 8 hours.

3) The method of claim 2 wherein said oxidizing step includes passing a stream of oxygen containing gas over said catalyst.

4) The method of claim 2 wherein said decomposing step includes passing a stream of inert gas over said catalyst.

5) The method of claim 2 wherein said reducing step includes passing a hydrogen containing gas over said catalyst.

6) The method of claim 2 wherein said reacting step includes reacting said catalyst under syngas reforming conditions for less than 2 hours.

7) A method for regenerating Ni-based catalysts comprising the steps of:
(1) oxidizing a used catalyst at 700 to 800° C. in 1% O₂ at less than 12,000 hr⁻¹ GHSV for 2 to 3 hours;
(2) decomposing said catalyst at 800 to 900° C. in Ar at 12,000 hr⁻¹ GHSV for 1 hour;
(3) reducing said catalyst at 800 to 900° C. in 2% H₂ at 24,000 hr⁻¹ GHSV for 1 hour;
(4) reacting said catalyst at 800 to 900° C. under biomass syngas reforming condition for 1 to 2 hours.
